(19) United States
(12) Patent Application Publication
(10) Pub. No.: US 2025/0329104 A1
(43) Pub. Date: Oct. 23, 2025

(54) VISUAL-INERTIAL GAUSSIAN SPLATTING SIMULTANEOUS LOCALIZATION AND MAPPING (VI-SLAM) SYSTEM WITH DENSE RECONSTRUCTION

(71) Applicant: Honda Motor Co., Ltd., Tokyo (JP)

(72) Inventors: Weihan WANG, San Jose, CA (US); Jinglun FENG, San Jose, CA (US); Nirav Bhagavanji SAVALIYA, San Jose, CA (US); Zheng-hang YEH, San Jose, CA (US)

(73) Assignee: Honda Motor Co., Ltd., Tokyo (JP)

(21) Appl. No.: 18/793,083

(22) Filed: Aug. 2, 2024

Related U.S. Application Data
(60) Provisional application No. 63/636,304, filed on Apr. 19, 2024.

(51) Int. Cl. G06T 15/08; G01C 21/16; G06T 7/73

(52) U.S. Cl. CPC G06T 15/08; G01C 21/16; G06T 7/74; G06T 2207/10024; G06T 2207/30244

(57) ABSTRACT

A method for visual-inertial simultaneous localization and mapping (VI-SLAM) may estimate an inertial measurement unit (IMU) bias using Interactive Closest Point (ICP) for estimating an acceleration bias. The method may estimate a camera pose of a current frame of a camera of the IMU using Red, Green, Blue (RGB) images and IMU measurements in real-time. The method may further perform dense mapping by managing a Gaussian map by optimizing 3D Gaussian parameters, expanding the Gaussian map, and compressing the Gaussian map by removing redundant Gaussians.

### RELATED APPLICATIONS

This patent application is related to U.S. Provisional Application No. 63/636,304 filed Apr. 19, 2024, entitled “VIN-Gauss SLAM: Real-time Visual-INertial Gaussian Splatting SLAM with Dense Reconstruction”, in the names of the same inventors and which is incorporated herein by reference in its entirety. The present patent application claims the benefit under 35 U.S.C. § 119(e) of the aforementioned provisional application.

### BACKGROUND

The integration of cameras with Inertial Measurement Units (IMUs) in Visual-Inertial Simultaneous Localization and Mapping (VI-SLAM) systems may offer a synergistic solution that may enhance robotic navigation and augmented reality applications. Cameras may provide detailed visual information about the surrounding scene, while IMUs may provide stability in environments lacking distinctive textures by measuring acceleration and angular velocities. This combination may be beneficial in dynamic scenarios where rapid motion and varying textures may disrupt localization stability.

In the past, advancements in VI-SLAM have focused on optimizing online initialization efficiency and improving the robustness of state estimation. As one of the pioneering works, Visual-Inertial Oriented FAST Rotated Brief (VIORB) may highlight the dependency of system accuracy on the initial estimation of camera and IMU alignment and scale, while Visual-Inertial Navigation System using a single camera and IMU (VINS-Mono) may further advance this field by offering a robust monocular visual-inertial system. VINS-Mono may integrate key components such as pre-integration techniques and a sliding window optimizer, enhancing state estimation robustness and accuracy, especially in dynamic environments. Recently, Error-state Kalman Filter Disjoint Initialization (EDI) introduced a disjoint approach that may utilize an Error-state Kalman Filter (ESKF) to estimate gyroscope bias and correct rotation estimates from monocular SLAM, while Stereo-NEC may demonstrate another innovative disjoint approach that integrates normal epipolar constraints to refine initialization in stereo VI-SLAM systems. Both studies may underscore a move towards reducing dependency on computational resources. Beyond the aforementioned methods, recent developments in neural scene representation may provide a pivot solution for dense SLAM integrates neural radiance fields (NeRFs), IMU, and SLAM to address open-world dynamics. This method may extend NICE-SLAM to accommodate larger, more complex environments by incorporating IMU data via pre-integration, which may condense multiple IMU measurements into a single relative motion increment.

However, challenges may remain, especially in ensuring real-time performance across diverse conditions and achieving reliable initialization that may affect the system's overall accuracy and robustness.

Present research may identify a gap in current dense Red, Green, Blue—Depth VI-SLAM, RGB-D VI-SLAM systems, particularly a need for more effective integration of robust tracking and dense mapping techniques. Existing approaches may struggle with high computational demands. In addition, the initialization phase of the visual-inertial system, which may be needed for accurate trajectory estimation, may lack the precision for needed scale and bias determination, which may be needed for accurate long-term tracking and localization. Moreover, while NeRF may offer detailed scene reconstructions by densely sampling environments, NeRF's extensive offline training and high computational demand during inference may limit its suitability for dynamic scenarios which may require quick updates. Additionally, NeRF may struggle with non-static scenes and scaling to large environments, leading to compromises between detail and performance.

Limitations and disadvantages of conventional and traditional approaches will become apparent to one of skill in the art, through comparison of described method with some aspects of the present disclosure, as set forth in the remainder of the present application and with reference to the drawings

### SUMMARY

According to an embodiment of the disclosure, a method for visual-inertial simultaneous localization and mapping (VI-SLAM) is provided. The method may estimate an inertial measurement unit (IMU) bias using Interactive Closest Point (ICP) for estimating an acceleration bias. The method may estimate a camera pose of a current frame of a camera of the IMU using Red, Green, Blue (RGB) images and IMU measurements in real-time. The method may further perform dense mapping by managing a Gaussian map by optimizing 3D Gaussian parameters, expanding the Gaussian map, and compressing the Gaussian map by removing redundant Gaussians.

According to an embodiment of the disclosure, a method for visual-inertial simultaneous localization and mapping (VI-SLAM), the method implemented using a control system including a processor communicatively coupled to a memory device is provided. The method may estimate an inertial measurement unit (IMU) bias comprising an acceleration bias and a gyroscope bias, wherein the acceleration bias is estimated using Interactive Closest Point (ICP) and the gyroscope bias is estimated using epipolar constraints within the first N frames of data, wherein a Gaussian map is initialized based on a first frame of a camera of the IMU. The method may estimate a camera pose of a current frame of the camera using a multi-scale ICP with Compute Unified Device Architecture (CUDA) acceleration and performing a rotation-translation-decoupled optimization to provide a starting point and updating the gyroscope bias during estimation of the camera pose. The method may further perform dense mapping by managing the Gaussian map by optimizing 3D Gaussian parameters, expanding the Gaussian map, and compressing the Gaussian map by removing redundant Gaussians.

According to an embodiment of the disclosure, a visual-inertial simultaneous localization and mapping (VI-SLAM) system is provided. The system may have an inertial measurement unit (IMU) unit estimating an inertial measurement unit (IMU) bias comprising an acceleration bias and a gyroscope bias, wherein the acceleration bias is estimated using Interactive Closest Point (ICP) and the gyroscope bias is estimated using epipolar constraints within the first N frames of data, wherein a Gaussian map is initialized based on a first frame of a camera of the IMU. The system may have an optimization unit estimating a camera pose of a current frame of the camera using a multi-scale ICP with Compute Unified Device Architecture (CUDA) acceleration and performing a rotation-translation-decoupled optimization to provide a starting point and updating the gyroscope bias during estimation of the camera pose. The system may have a dense reconstruction unit performing dense mapping by managing the Gaussian map by optimizing 3D Gaussian parameters, expanding the Gaussian map, and compressing the Gaussian map by removing redundant Gaussians.

### BRIEF DESCRIPTION OF THE DRAWINGS

FIG. 1 is a diagram illustrating pairs of unit bearing vectors from cameras pointing to respective 3D landmarks over two consecutive times involve in accordance with an embodiment of the disclosure;

FIG. 2 is a block diagram of an exemplary Visual-Inertial Gaussian Splatting Simultaneous Localization and Mapping (VIN-Gauss SLAM) system for real-time dense mapping for detailed environmental understanding and maintaining real-time tracking performance in accordance with an embodiment of the disclosure;

FIGS. 3A-3D are illustrations comparing the exemplary VIN-Gauss SLAM system with other systems in accordance with an embodiment of the disclosure;

FIG. 4 are illustrations comparing the exemplary VIN-Gauss SLAM system with other systems in accordance with an embodiment of the disclosure;

FIG. 5 are illustrations comparing the exemplary VIN-Gauss SLAM system with other systems in accordance with an embodiment of the disclosure;

FIG. 6 is a block diagram of a computer-readable medium or computer-readable device including processor-executable instructions for implementing the exemplary VIN-Gauss SLAM system, in accordance with an embodiment of the disclosure; and

FIG. 7 is a block diagram of a computer system for implementing the exemplary VIN-Gauss SLAM system, in accordance with an embodiment of the disclosure.

### DETAILED DESCRIPTION

Unlike existing VI-SLAM systems and methods that primarily focus on tracking using a sparse map, one may propose a real-time Visual-Inertial Gaussian Splatting Simultaneous Localization and Mapping (VIN-Gauss SLAM) system and method which may enhance both the visual-inertial initialization process and the integration of dense mapping. The present system and method may deliver real-time dense mapping for more detailed environmental understanding while maintaining precise real-time tracking performance. To achieve this, VIN-Gauss SLAM may integrate robust IMU initialization techniques to estimate precise gyroscope bias, which may enhance rotation accuracy. This improvement may reduce the accumulation of translation errors, which may increase trajectory accuracy. One may then utilize Compute Unified Device Architecture (CUDA) based multi-scale Interactive Closest Point (ICP) which may be used to accurately estimate the camera pose in real time. The implementation of 3D Gaussian splatting may enable efficient scene reconstruction and may support faster differentiable scene updates and gyroscope bias adjustments, which may be needed for maintaining high accuracy and computational efficiency. Additionally, one may introduce an improved keyframe selection strategy that may enhance performance in real-world scenarios. Extensive experiments have been conducted which may show that the present approach may outperform existing methods in terms of tracking accuracy, initialization robustness, and computational cost, making it highly effective across diverse conditions.

### IMU Pre-Integration

IMU pre-integration is a method that may aggregate multiple IMU measurements into a function of the IMU biases, which may allow for the efficient integration of acceleration and angular velocity measurements without needing to recompute them when biases are updated. This technique, initially introduced to the manifold space, may simplify the integration process by approximating the IMU biases as a first-order function, which may streamline the computational load in systems like SLAM that may require real-time processing. The reintegration formula, shown in Equation 1 below, may linearize the biases to optimize the response in the system to bias changes within a nonlinear least squares framework.

$${γ}_{j}^{i} \approx {\hat{γ}}_{j}^{i} Exp ( {J}_{{b}_{g}}^{γ} δ {b}_{g} ) \qquad ( 1 )$$

$${β}_{j}^{i} \approx {\hat{β}}_{j}^{i} + {J}_{{b}_{a}}^{β} δ {b}_{a} + {J}_{{b}_{g}}^{β} δ {b}_{g}$$

$${α}_{j}^{i} \approx {\hat{α}}_{j}^{i} + {J}_{{b}_{a}}^{α} δ {b}_{a} + {J}_{{b}_{g}}^{α} δ {b}_{g}$$

where δb(·) may denote the change in bias estimation. The Jacobians J^{γ}(·), J^{β}(·), and J^{α}(·) may describe how the pre-integration measurements may change in response to a change in the bias estimation. Additionally,

$${\hat{γ}}_{j}^{i} , {\hat{β}}_{j}^{i} , and {\hat{α}}_{j}^{i}$$

may represent the previous pre-integration measurements. This capability may make IMU particularly effective in environments lacking distinct textures or under dynamic conditions, enhancing the robustness of sensor fusion applications in SLAM systems.

### Normal Epipolar Constraint

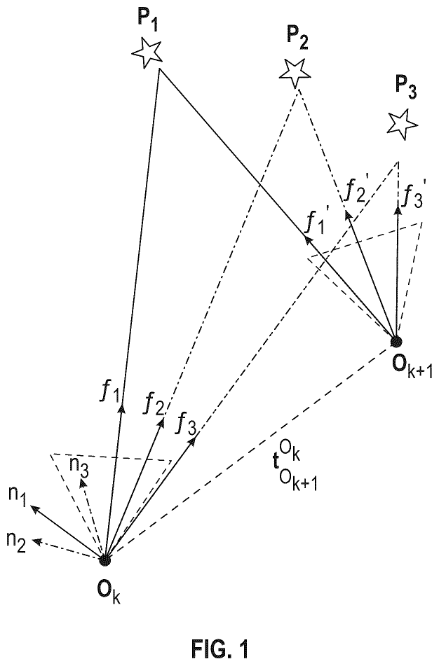

The normal epipolar constraint may describe the geometric relationship between normal vectors and their corresponding epipolar planes, asserting that these vectors are coplanar. As illustrated in FIG. 1, cameras at consecutive times k and k+1 may be represented by the dashed triangles with optical centers Oₖ and Oₖ₊₁. The bearing vectors fᵢ and f′ᵢ along with the relative rotation

$$( {R}_{ck + 1}^{ck} )$$

may determine the normal vectors

$${n}_{i} = {f}_{i} \times {{R}^{ck}}_{ck + 1} {{f}^{′}}_{i} .$$

Assuming that N pair of 3D points (Pᵢ) may be observed, then N normal vectors of epipolar planes may be stacked into a matrix N=[n₁ . . . nₙ]. By ensuring the minimum eigenvalue of M=NN^{T} is zero, coplanarity may be mathematically fulfilled, which may support robust applications even in intensely rotational scenarios. This constraint may be integrated with IMU pre-integration for initializing camera rotation and gyroscope bias correction, which may be further detailed below.

### 3D Gaussians Splatting

3D Gaussian splatting may be used for explicit 3D scene representation, rapidly projecting parameterized 3D Gaussians onto a pixel-based image plane. Each Gaussian, characterized by its opacity αₖ∈[0, 1], center pₖ∈R³, scale sₖ∈R³, and orientation via a rotation matrix Rₖ, may influence space points x∈R³ to form anisotropic ellipsoids. The shape and size of these ellipsoids may be controlled by a 3D covariance matrix Σₖ, which may be derived from the Gaussian's scale and rotation attributes. Additionally, spherical harmonics coefficients may be used to accurately render the Gaussian's color, capturing the view-dependent scene appearance. This rendering process, formulated as shown in Equation 2 below, may optimize scene realism and depth perception efficiently, where

$${\sum }_{k} = {R}_{k} {s}_{k} {{s}_{k}}^{T} {{R}_{k}}^{T} .$$

$${k}_{} ( x ) = exp ( - \frac{1}{2} {( x - {p}_{k} )}^{T} {\sum }_{k}^{- 1} ( x - {p}_{k} ) ) \qquad ( 2 )$$

The process of rendering a Red, Green, Blue (RGB) image may take as input a collection of 3D Gaussians and a camera pose (Tₖ). First, all Gaussians may be transformed from the world frame to the camera frame using the transformation matrix W and projected onto the image plane via Equation 3 below, which may describe a local affine transformation J:

$${\sum }_{k}^{′} = JW {\sum }_{k} {W}^{⊤} {J}^{⊤} \qquad ( 3 )$$

When projecting 3D Gaussians onto the image plane, the third row and column of the covariance matrix

$${\sum }_{k}^{′}$$

may be omitted to derive a 2D Gaussian

$${{G}_{k}}^{2 D}$$

with the corresponding 2D covariance matrix

$${\sum }_{k}^{2 D} .$$

The Gaussians may then be sorted by depth, from nearest to furthest. The RGB images may be subsequently rendered using alpha-blending, where the 2D projections of the Gaussians may be sequentially splatted onto the image plane, ensuring proper layering and depth-based visibility.

### VIN-Gauss SLAM Approach

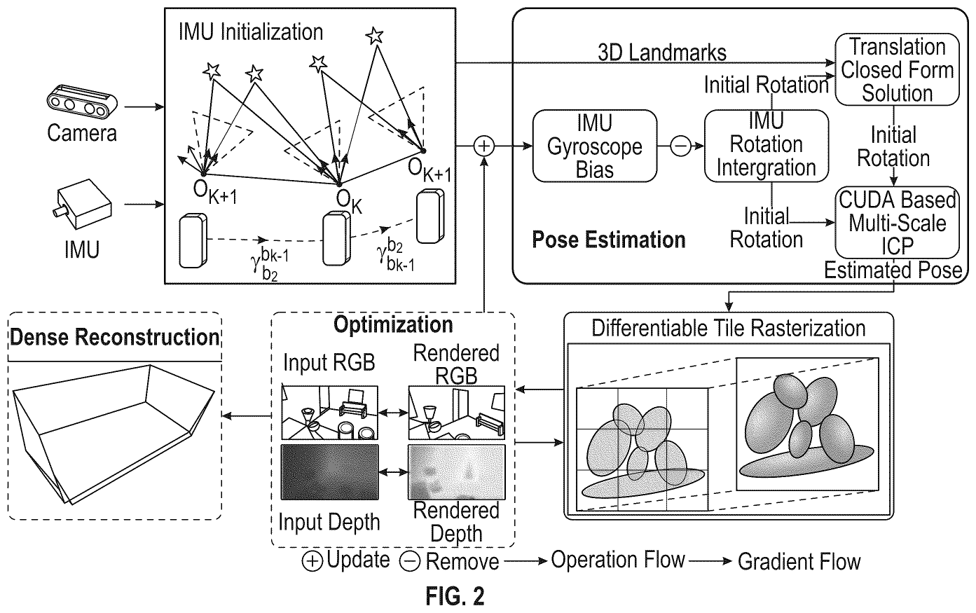

As may be shown in FIG. 2, one may propose the first dense RGB-D VI-SLAM solution that may fully leverage the robustness of IMU against texture-less and environmental changes, may utilize 3D Gaussians for dense volumetric representation, and may employs 3D Gaussian splatting for scene updates.

The present VI-SLAM system and method may consist of the following steps:
IMU Initialization: One may obtain an initial accurate estimate of the gyroscope bias using normal epipolar constraints within the first N frames, which may be used for IMU initialization. In addition to IMU initialization, one may also initialize the Gaussian map based on the first frame.
Real-time Tracking: One may leverage a CUDA-based, multi-scale ICP method for tracking, providing with an initial seed of the relative pose obtained through a rotation-translation-decoupled optimization.
Dense Mapping: One may determine if an incoming frame is a keyframe based on average parallax or visual similarity. New Gaussians from the new keyframe may be added to the existing Gaussians map based on the rendered silhouettes and input depth. Subsequently, one may update the map by optimizing the parameters of all 3D Gaussians, aiming to minimize the residuals in both RGB and depth.

In practice, one may find that treating 3D Gaussians as either anisotropic or isotropic does not significantly affect rendering performance. To accelerate real-time performance, one may adopt a similar approach, forcing 3D Gaussians to be isotropic, which means they have spherical covariance and view-independent color. Therefore, 3D Gaussians may be represented by modifying Equation 2 to the following Equation 4 as shown below:

$${k}_{3 D}^{} ( x ) = exp ( - \frac{{‖ x - {p}_{k} ‖}^{2}}{2 {r}^{2}} ) \qquad ( 4 )$$

where r may be the radius, initialized by dividing the depth of the k-th 3D Gaussian by the focal length. Meanwhile, the color rendering equation may be adjusted accordingly as may be shown in Equation 5 below:

$$C ( x ) = {\sum }_{k = 1}^{K} {c}_{k} {α}_{k} {k}_{3 D}^{} ( x ) {\prod }_{i = 1}^{k - 1} ( 1 - {α}_{j} {j}_{3 D}^{} ( x ) ) . \qquad ( 5 )$$

One may also utilize alpha compositing to render the depth map and silhouette image, which may be used to determine visibility as shown in Equation 6 and 7 below.

### Depth Image Rendering:

$$D ( x ) = {\sum }_{k = 1}^{K} {d}_{k} {α}_{k} {𝒢}_{k}^{3 D} ( x ) {\prod }_{j = 1}^{k - 1} ( 1 - {α}_{j} {𝒢}_{j}^{3 D} ( x ) ) . \qquad ( 6 )$$

where D(x) may denote the rendered depth at the 3D position x and dₖ may be the depth of the k-th Gaussian in the camera frame.

### Silhouette Image Rendering:

$$S ( x ) = {\sum }_{k = 1}^{K} {α}_{k} {𝒢}_{k}^{3 D} ( x ) {\prod }_{j = 1}^{k - 1} ( 1 - {α}_{j} {𝒢}_{j}^{3 D} ( x ) ) . \qquad ( 7 )$$

where S(x) may denote the visibility information at the 3D position x.

### IMU Initialization

IMU initialization may be an important step that may affect the accuracy and usability of VI-SLAM. A dependable IMU initialization may be needed for accurately and quickly recovering IMU biases, including both acceleration and gyroscope biases, since a prolonged initialization process may be impractical. During the IMU initialization phase, the gyroscope bias may be estimated relatively easily, but the acceleration bias may be more challenging to determine since it tends to be coupled with gravity, making them difficult to separate. To avoid estimating an incorrect acceleration bias, which may lead to poor translation estimation, one may base translation estimates on ICP. Rotation may be estimated by performing IMU integration with the gyroscope bias removed from the gyroscope measurements. This approach may realize the importance of gyroscope bias for accurate rotation estimation.

Specifically, one may estimate the optimal gyroscope bias using normal epipolar constraints within the first N frames. The optimal gyroscope bias, denoted as b*_{g}, may be estimated by minimizing the smallest eigenvalue of each M_{k-1, k} as outlined in Equation (8) shown below. Each M_{k-1, k} may be constructed using a set of normal vectors between two consecutive frames. With the introduction of the IMU, a normal vector (nᵢ) may be represented by

$${f}_{i} \times {R}_{b}^{c} {\hat{Y}}_{bk}^{bk - 1} {R}_{c}^{b} {f}_{i}^{′} .$$

If one may use N frames to estimate the gyroscope bias, one may obtain N−1 matrices of M_{k-1, k}.

$${b}_{g}^{*} = arg {min}_{{b}_{g}} {\sum }_{( k - 1 , k ) ∈ ε} {‖ ( {λ}_{min} ( {M}_{k - 1 , k} ) ‖}^{2} \qquad ( 8 )$$

$${M}_{k - 1 , k} = {\sum }_{i = 1}^{n} ( {f}_{i} \times {R}_{b}^{c} {\hat{γ}}_{{b}_{k}}^{{b}_{k - 1}} {R}_{c}^{b} {f}_{i}^{′} ) {( {f}_{i} \times {R}_{b}^{c} {\hat{γ}}_{{b}_{k}}^{{b}_{k - 1}} {R}_{c}^{b} {f}_{i}^{′} )}^{⊤}$$

$${\hat{γ}}_{{b}_{k}}^{{b}_{k - 1}} = {γ}_{{b}_{k}}^{{b}_{k - 1}} Exp ( {J}_{{b}_{g}}^{γ} {b}_{g} )$$

where (fᵢ, f′ᵢ) may denotes a pair of bearing vectors in the RGB camera. n may denote the number of features observed by the RGB camera.

$${R}_{c}^{b}$$

may represent the rotation matrix of the RGB camera-IMU extrinsic calibration. M_{k-1, k} may be formed by using the normals from the RGB camera. ε may signify a set of keyframe pairs at two consecutive times.

$${\hat{Y}}_{bk}^{bk - 1}$$

may be estimated using a first-order Taylor approximation of

$${Y}_{bk}^{bk - 1}$$

and

$${J}_{b g}^{Y}$$

may represents how the pre-integration of rotation may change due to a small difference in gyroscope bias estimation.

After attaining gyroscope bias, one may update each camera rotation estimate,

$${R}_{c k}^{w} ,$$

within the first N frames via IMU rotation integration in Equation (9):

$$( {γ}_{{b}_{k}}^{{{b}_{k - 1}}^{*}} ) = {γ}_{{b}_{k}}^{{b}_{k - 1}} Exp ( {J}_{{b}_{g}}^{γ} {b}_{g}^{*} ) \qquad ( 9 )$$

$${R}_{{b}_{k}}^{w} = {R}_{{b}_{k - 1}}^{w} {γ}_{{b}_{k}}^{{{b}_{k - 1}}^{*}}$$

$${R}_{{c}_{k}}^{w} = {R}_{{b}_{k}}^{w} {R}_{c}^{b}$$

where

$${( {Y}_{bk}^{bk - 1 *} )}^{may}$$

represent the updated pre-integration of rotation using the updated gyroscope bias (b*_{g}).

### Real-Time Tracking

The tracking stage may aim to estimate the camera pose of the current frame using associated RGB-D images and IMU measurements in real-time. Traditional methods may employ inverse optimization by fixing the Gaussian parameters and updating the input view pose, but these methods may suffer from limited frames per second (FPS). To address this, one may utilize a multi-scale ICP with CUDA acceleration to estimate the camera pose. The accuracy of ICP may rely on having a good initial transformation; thus, one may perform a rotation-translation-decoupled optimization to provide a precise starting point. This approach may not only accelerate tracking speed but also may maintain accuracy. Specifically, rotation-translation-decoupled optimization may first estimate the relative rotation between the previous and current frames using IMU pre-integration of rotation and the camera-IMU calibration matrix, represented as

$${R}_{ck + 1}^{ck} ,$$

as shown below in corresponding Equation (10):

$${R}_{{c}_{k}}^{{c}_{k - 1}} = {R}_{b}^{c} ( {γ}_{{b}_{k}}^{{{b}_{k - 1}}^{*}} ) {R}_{c}^{b} \qquad ( 10 )$$

Once one may have the initial relative rotation, one may use it to estimate the initial relative translation, denoted as t^{ck}_{ck+1}, as detailed in Equation (11) below:

$${t}_{{c}_{k}}^{{c}_{k} - 1} = {\overline{p}}_{k - 1} - {R}_{{c}_{k}}^{{c}_{k - 1}} {\overline{p}}_{k} \qquad ( 11 )$$

where centroids [symbol] and [symbol] may represent the average points of all 3D points generated by the previous frame and the current frame, respectively. The 3D points for each frame may be generated from their associated depth maps.

After establishing a good initial transformation, which may be denoted as:

$$[ {R}_{c k}^{ck - 1} \vert {t}_{c k}^{ck - 1} ] ,$$

one may further refine this transformation using multi-scale ICP. Then, one may apply the refined relative transformation to the pose from the previous frame

$$( [ {R}_{ck - 1}^{w} \vert {t}_{ck - 1}^{w} ] )$$

to determine the pose of the current frame

$$( [ {R}_{c k}^{w} \vert {t}_{c k}^{w} ] )$$

Besides updating the camera pose, one may also iteratively update the gyroscope bias during the tracking stage to maintain accurate rotation estimation. This may be achieved by differentially rendering RGB, depth, and silhouette maps, and adjusting the gyroscope bias to minimize the loss between the rendered images (color, depth, and silhouette) and the corresponding input images while keeping the Gaussian parameters fixed, as may be illustrated in Equation 12 below:

$$\begin{matrix}{u}_{k} = K ( {R}_{{c}_{k}}^{w} {}^{⊤} ( {p}_{k} - {t}_{{c}_{k}}^{w} ) ) \\ {b}_{g}^{*} = arg {min}_{{b}_{g}} {\sum }_{{p}_{k}} {‖ e ‖}^{2} \\ e = ( S ( {p}_{k} ) > 0.99 ) ( {L}_{1} ( D ( {p}_{k} ) ) + 0.5 {L}_{1} ( C ( {p}_{k} ) ) )\end{matrix} \qquad ( 12 )$$

where K may be the camera intrinsic matrix, pₖ may be the center position of a 3D Gaussian, and uₖ∈R² may be the 2D projection of this Gaussian in image space. Specifically, the gyroscope bias estimate (b_{g}) may be updated iteratively using the Levenberg-Marquardt algorithm. To apply the Levenberg-Marquardt algorithm, one may need the Jacobian matrix of the gyroscope bias with respect to the error (e). This Jacobian matrix can be computed by following the chain rule in Equation 13 below:

$$\frac{\partial e}{\partial {b}_{g}} = \frac{\partial e}{\partial {p}_{k}} \frac{\partial {p}_{k}}{\partial {R}_{{c}_{k}}^{w}} \frac{\partial {R}_{{c}_{k}}^{w}}{\partial {γ}_{{b}_{k}}^{{b}_{k - 1}}} {J}_{{b}_{g}}^{γ} \qquad ( 13 )$$

### Dense Mapping

The mapping stage may aim to manage the Gaussian map by optimizing the 3D Gaussian parameters, expanding the existing map, and compressing it by removing redundant Gaussians. The mapping may comprise three components: Map Initialization, Densification, and Optimization.

### 3D Gaussian Map Initialization:

One may initialize Gaussians X₀ with a module φ₀. Given X₀=(φ₀(I₀, D₀, K, T₀, θ₀), one may take the first input image I₀, depth map D₀, camera intrinsic matrix K, and camera pose T₀ to generate the initial Gaussians X₀ and their parameters 60.

### Densification:

As the Gaussian Map grows incrementally, one may need to control the size of the Gaussians in the map to avoid adding Gaussians where they already exist or where two Gaussians may be too close. To address this, one may use a densification procedure to determine which pixels may need to be added as new Gaussians. This procedure may only be triggered when the current frame is selected as a keyframe. The densification procedure may be achieved using a densification mask, which may identify pixels where new Gaussians may need to be added. The mask may be applied to pixels where the silhouette value may be less than 0.5, where the depth at the pixel may be in front of the predicted depth, or where the depth error may be greater than 50 times the median depth error.

Keyframes may be determined based on their difference from the previous keyframe. One may hash each incoming RGB image using perceptual hashing, which may generate similar hash values for images that look alike, which may allow for the detection of duplicates or visually similar images. One may then compare the hash value of the incoming image to the hash values of the keyframes using Hamming distance. If the Hamming distances between the current image and all keyframes in the buffer are greater than a threshold A, one may consider the current input frame to be a new keyframe.

### Optimization:

In the optimization module, one may optimize the 3D Gaussians observed by a subset of keyframes that overlap with the current frame. Optimizing over all previous keyframes may be inefficient, so one may select frames likely to influence the newly added Gaussians. One may maintain a keyframe buffer used for map updates. In this buffer, one may select k−2 keyframes with strong co-visibility with the current frame, as well as the most recent keyframe. This process may adjust the parameters of the 3D Gaussians while keeping the camera pose fixed. Strong co-visibility may be determined by treating the current frame as a node and identifying k−2 edges with keyframes in the buffer. These edges may exist if the keyframes share the most map points with the current frame. Once the optimization of the current Gaussian map is complete, one may need to prune the 3D Gaussians by removing those with an opacity less than the threshold T.

### EXPERIMENTAL STUDY

### Experimental Settings

### Datasets:

The above method was evaluated using several datasets, including Replica, TUM, and a self-captured dataset. All room and office sequences from the Replica dataset were used for tracking and mapping comparison experiments. Three sequences from the TUM dataset were selected due to their complexity and relevance to real-world scenarios. Additionally, to test the method's fidelity, a dataset was collected using a RealSense D435i camera to evaluate the robustness and effectiveness of the method under real-world lighting and motion conditions. Specifically, seven different indoor sequences were collected across various scenarios. An OptiTrack system was used to capture the ground truth, including RGB images, depth images, and IMU measurements.

### Evaluation Metrics:

The performance of the above proposed SLAM system may be quantitatively evaluated using several metrics. Absolute Trajectory Error (ATE) and Relative Pose Error (RPE) were calculated to assess the accuracy of trajectory estimation. Additionally, Peak Signal-to-Noise Ratio (PSNR), Depth L1 error, Structural Similarity Index Measure (SSIM), and Learned Perceptual Image Patch Similarity (LPIPS) were used to evaluate the quality of mapping and novel view synthesis.

### Pseudo IMU Measurements:

Due to the fact that Replica and TUM datasets may not provide IMU measurements, one may have to introduce pseudo-IMU measurements within these datasets to ensure the seamless execution of the proposed method.

An angular velocity measurement uᵢ at time tᵢ, which is between tₖ₋₁ and tₖ, may be derived from the ground truth of the two consecutive relative rotations from tₖ₋₁ to tₖ as may be shown in Equation 14 below:

$${u}_{i} = \frac{Log ( {R}_{w}^{{b}_{k - 1}} {R}_{{b}_{k}}^{w} )}{{t}_{k}} + {η}_{θ} \qquad ( 14 )$$

where the angular velocity measurement noise, η_{θ}, may follow a normal distribution N(0, σ²_{wn}Δt²I), where the standard deviation σ_{wn} of the angular velocity measurement noise may be set to 1.7×10-4 rad/s.

### Baseline Methods:

The evaluation may benchmark against two state-of-the-art (SOTA) methods: Splatam and ORB-SLAM3. Splatam may be acclaimed for its adept handling of dense environments through the use of 3D Gaussian Splattings, offering localization fidelity. On the other hand, ORB-SLAM3, a conventional feature based method, may be distinguished for its robust performance in both visual-only and visual-inertial scenarios, which may make it a benchmark in the study.

### Implementation Details:

During the experimental study, one may set the threshold λ to 30 in all real-world related experiments such as TUM and the collected dataset while setting λ to 15 in synthetic datasets such as Replica. For pruning, one may set T=0.005, removing any 3D Gaussian with log(opacity)<T. All evaluations may be conducted on a desktop configured with an Intel Core i9-13900K CPU and an NVIDIA RTX A5000 GPU. The implementation may utilize CUDA for real-time rasterization and gradient calculations of 3DGS, while the remainder of the SLAM pipeline was developed in PyTorch.

### Comparison Study

### Quantitative Evaluation:

As shown in Table I below, the above disclosed method may demonstrate improved performance across several key metrics. Regarding ATE translation, VIN-Gauss SLAM may outperform Splatam, achieving 0.17 cm in room 0 and 0.11 cm in office 1, compared to Splatam's 0.34 cm in room 0 and 0.27 cm in office 1, highlighting the above method's precision in trajectory estimation. Moreover, in RPE translation, VIN-Gauss SLAM may achieve low errors, such as 0.026 cm in office 1 and 0.056 cm in room 0, compared to Splatam's higher errors of 0.081 cm in room 0 and 0.072 cm in room 1. Similarly, in RPE rotation, the above method may record minimal errors, such as 0.0224 degrees in room 0, whereas Splatam shows higher values, such as 0.0258 degrees. This may indicate enhanced capability in maintaining accurate relative pose estimation.

In terms of visual quality, the above method may consistently achieve higher PSNR values, such as 39.46 in office 1, compared to Splatam's 39.09. Additionally, VINGauss SLAM may show lower Depth L1 errors, with 0.27 cm in office 1 and 0.51 cm in room 1, outperforming Splatam's 0.28 cm and 0.44 cm respectively. Furthermore, the SSIM scores from the above proposed method may be higher, indicating better structural similarity and image quality; for example, achieving 0.987 in office 1 compared to Splatam's 0.981. Lastly, VINGauss SLAM may record lower LPIPS values, such as 0.050 in office 1, compared to Splatam's 0.097, which may indicate better perceptual quality of the reconstructed images. Overall, the comparative study may demonstrate that the present method may consistently outperform Splatam across a variety of metrics, underscoring the robustness and efficiency of VINGauss SLAM in complex environments and dynamic scenes.

Moreover, Table II as may be seen below, may present the comparative results from the self-captured dataset between VIN-Gauss SLAM and other baseline systems, including both the standard and inertial versions of ORB-SLAM3. The outcomes may show that the above method is on par with the inertial version of ORB-SLAM3 and surpasses the visual only ORB-SLAM3 system and the state-of-the-art Gaussian Splatting based baseline, Splatam. In particular, VINGauss SLAM may achieve competitive ATE results across all sequences, closely matching the ORB-SLAM3 Inertial version and outperforming Splatam. Additionally, the above proposed method may record low RPE results, especially in terms of rotational accuracy. The tests conducted on the self-captured dataset, which may feature real-world lighting and imperfect motion conditions, may demonstrate that despite the robustness of visual-inertial systems like ORB-SLAM3, the above proposed method, with its novel tracking strategy, not only competes effectively but often surpasses the performance of established methods in realistic environments. This may highlight the robustness and precision of VIN-Gauss SLAM.

### Qualitative Evaluation:

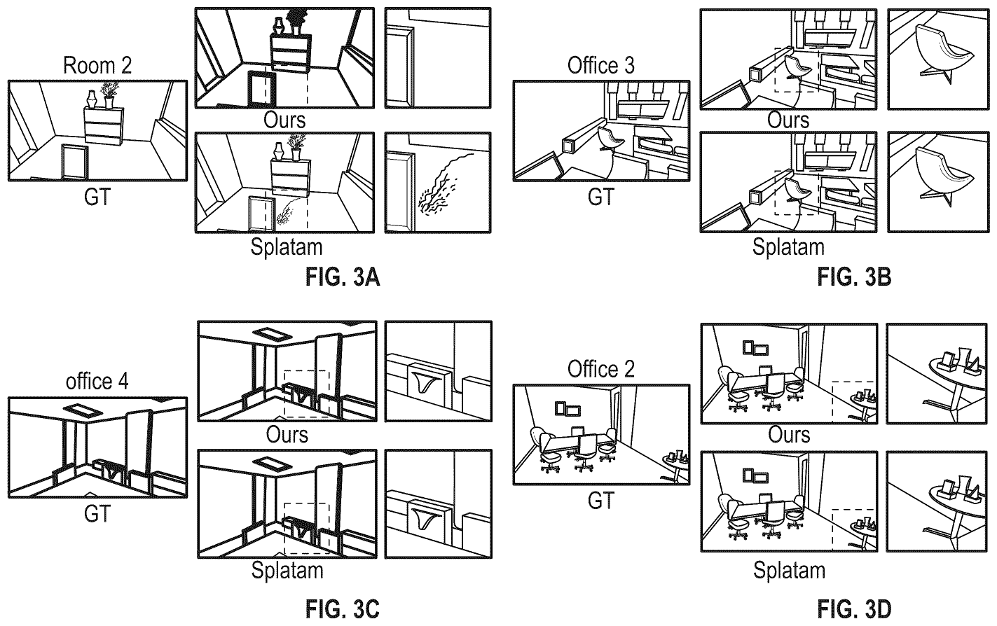

In addition, one may illustrate the qualitative comparisons as may be shown in FIGS. 3A-3D. Specifically, one may showcase the reconstruction results in four different scenarios from the Replica dataset. In the comparison results from room 2 (FIG. 3A), Splatam's reconstruction model may exhibit artifacts such as blurring and texture inconsistencies, particularly noticeable in the highlighted areas on the floor and the edges of the chair, while the above disclosed method offers a clear and consistent reconstruction. Similar results may be shown in the office 3 scenario (FIG. 3B), where the above identified method provides a clean view at the back of the chair, whereas Splatam produces a noisy background. Moreover, in office 4 (FIG. 3C) and office 2 (FIG. 3D) scenarios, it may be seen that VIN-Gauss SLAM outperforms the baseline method in capturing details, such as the edges of the table and the objects on the coffee table. These qualitative comparisons underscore the challenges in achieving high-fidelity 3D reconstructions and highlight specific areas where further improvements may be necessary.

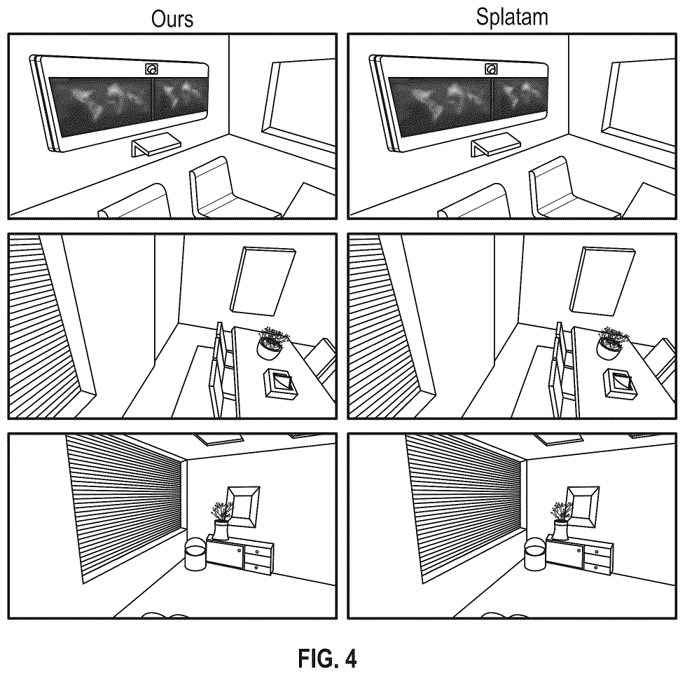

Besides reconstruction details, one may also conduct the experiments on novel view synthesis, as may be shown in FIG. 4. Notably, the above proposed method may maintain a view consistency on novel views while having a clear detail reconstruction. These visual results distinctly underscore VIN-Gauss SLAM's ability to generate perceptually coherent and geometrically accurate viewpoints within synthetically reconstructed environments.

### Ablation Study

Two separate ablation studies were conducted on two different strategies.

### Keyframe Selection:

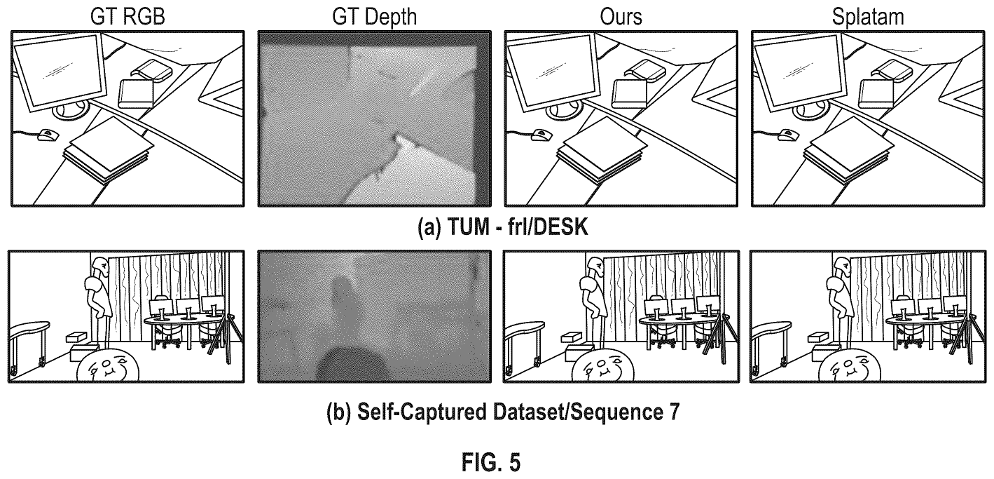

In this experiment, one may evaluate various keyframe selection strategies within the above proposed framework. Initially, one may adopt the same strategy as the baseline method, which may involve selecting a keyframe every five frames and storing it in a keyframe database. During optimization, a random selection of k frames may be made, encompassing the current and the most recent keyframe, along with k−2 prior keyframes that may demonstrate the highest over-lap with the current frame. One may discover, however, that this rigid approach to keyframe selection may be effective on synthetic datasets but may perform sub-optimally under real-world conditions. This may be attributed to the often-noisy depth images in real-world environments, which may result in the initialization of overly noisy 3D Gaussians that may defy effective optimization, regardless of the number of optimization rounds. Moreover, the continual addition of noisy 3D Gaussians every five frames may deteriorate the overall quality of the reconstructed scene. Consequently, VIN-Gauss SLAM may adopt a simpler and more intuitive approach, adding a keyframe only when there may be a significant change in the viewpoint from the last one. As may be illustrated in FIG. 5, one may demonstrate the differences between the two keyframe selection methods in datasets that are under real-world scenarios, where depth data tend to be noisier than their synthetic counterparts. Remarkably, the above proposed method may maintain clarity in the rendered scene despite the presence of noisy input depth, whereas the strategy used by Splatam may suffer due to the accumulation of noisy 3D Gaussians in the scene.

### Tracking Strategy:

One may also conduct an ablation study on various tracking strategies. Similar to radiance field-based methods like NICE-SLAM, Splatam may prefer a joint learning approach for pose estimation during tracking. However, this joint optimization method may often require lengthy optimization iterations that may result in a costly computational time. Therefore, one may compare the tracking time cost between the above proposed method and the original method, as shown in Tab. Ill below. Notably, the proposed IMU aided tracking method may not require any jointly optimization during the optimization of 3D Gaussians map, allowing us to achieve a relatively high tracking FPS compared to the baseline, while still obtaining better ATE results over three TUM sequences.

TABLE III
Tracking strategy comparisons on TUM dataset between the
above proposed method and Splatam in terms of Tracking
FPS (↑) and ATE ([cm] ↓).

| | Ours | Splatam |
|---|---|---|
| Avg. Tracking FPS (↑) | 10.03 | 1.27 |
| Avg. ATE ([cm] ↓) | 7.45 | 10.51 |
| fr1/room ATE ([cm] ↓) | 12.42 | 10.46 |
| fr2/xyz ATE ([cm] ↓) | 5.33 | 4.62 |
| fr3/long ATE ([cm] ↓) | 4.59 | 16.46 |

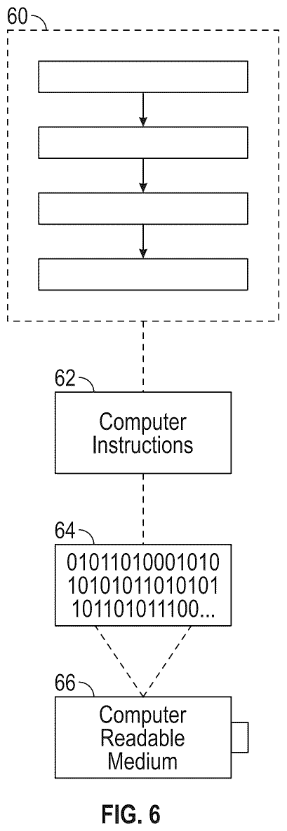

The present disclosure may be embedded in a computer program product, which includes all the features that enable the implementation of the methods described herein, and which when loaded in a computer system is able to carry out these methods. Referring to FIG. 6, in this embodiment, the method disclosed above and represented as 60 may include a computer-readable medium 66, such as a CD-R, DVD-R, flash drive, a platter of a hard disk drive, etc., on which may be encoded computer-readable data 64. This encoded computer-readable data 64, such as binary data may include a plurality of zeros and ones, in turn may include a set of processor-executable computer instructions 62 configured to operate according to one or more of the principles set forth herein. In this embodiment, the processor-executable computer instructions 62 may be configured to perform the method 60. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

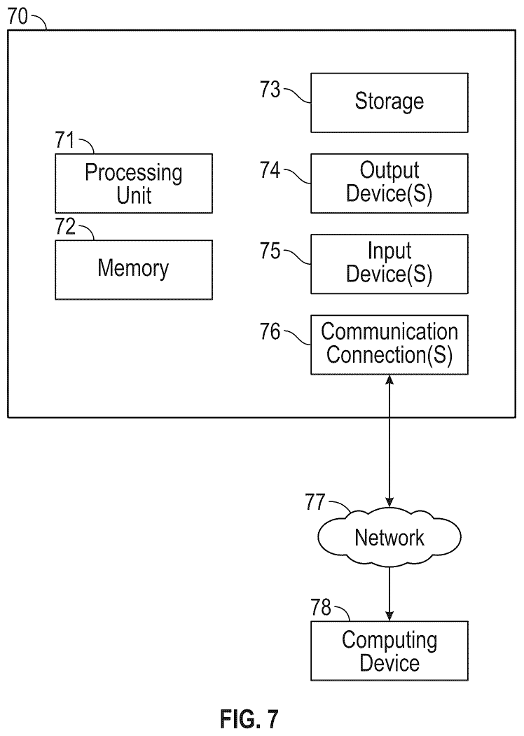

Referring to FIG. 7, a computing device 70 may be used to implement one aspect provided herein. In accordance with an embodiment, the computing device 70 may include at least one processing unit 71 and memory 72. Depending on the type of computing device, the memory 72 may be volatile, such as RAM, non-volatile, such as ROM, flash memory, etc., or a combination of the two.

In other aspects, the computing device 70 may include additional features or functionality. For example, the computing device 70 may include additional storage such as removable storage or non-removable storage, including, but not limited to, magnetic storage, optical storage, etc. Such additional storage may be illustrated in FIG. 7 by storage 73. In one embodiment, computer readable instructions to implement one aspect provided herein are in storage 73. Storage 73 may store other computer readable instructions to implement an operating system, an application program, etc. Computer readable instructions may be loaded in the memory 72 for execution by the processing unit 71, for example.

The computing device 70 may include input device(s) 74 such as keyboard, mouse, pen, voice input device, touch input device, infrared cameras, video input devices, or any other input device. Output device(s) 75 such as one or more displays, speakers, printers, or any other output device may be included with the computing device 70. Input device(s) 74 and output device(s) 75 may be connected to the computing device 70 via a wired connection, wireless connection, or any combination thereof. In one embodiment, an input device or an output device from another computing device may be used as input device(s) 74 or output device(s) 75 for the computing device 70. The computing device 70 may include communication connection(s) 76 to facilitate communications with one or more other devices 77, such as through network 77, for example.

In conclusion, VIN-Gauss SLAM may provide an advanced real-time Visual-Inertial SLAM system with dense reconstruction capabilities, integrating robust IMU initialization with 3D Gaussian Splatting. VIN-Gauss SLAM may address key challenges in existing VI-SLAM systems, demonstrating superior performance in trajectory estimation accuracy, visual reconstruction quality, and tracking speed compared to state-of-the-art baselines. Extensive experiments on synthetic and real-world datasets may validate the effectiveness and robustness of the above method in diverse environments, particularly in challenging conditions. The integration of IMU data with 3D Gaussian splatting enables real-time dense mapping without compromising accuracy or efficiency. This method may provide a significant advancement in VI-SLAM technology, offering a robust solution that balances accuracy, speed, and dense reconstruction capabilities. Future work could explore optimizations for larger-scale environments and increase the mapping quality and time cost on optimization.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the particular embodiment disclosed, but that the present disclosure will include all embodiments that fall within the scope of the appended claims

1. A method for visual-inertial simultaneous localization and mapping (VI-SLAM), comprising:
estimating an inertial measurement unit (IMU) bias using Interactive Closest Point (ICP) for estimating an acceleration bias;
estimating a camera pose of a current frame of a camera of the IMU using Red, Green, Blue (RGB) images and IMU measurements in real-time; and
performing dense mapping by managing a Gaussian map by optimizing 3D Gaussian parameters, expanding the Gaussian map, and compressing the Gaussian map by removing redundant Gaussians.

2. The method of claim 1, wherein estimating an inertial measurement unit (IMU) bias comprises initializing the Gaussian map based on a first frame of the camera.

3. The method of claim 1, wherein estimating the IMU bias comprises estimating a gyroscope bias using epipolar constraints within a first predetermined number N frames of data.

4. The method of claim 3, wherein estimating the accelerating bias comprises performing IMU integration with the gyroscope bias removed from gyroscope measurements.

5. The method of claim 3, wherein the gyroscope bias is estimated by minimizing a smallest eigen value for each vector formed by using a set of normal vectors between two consecutive frames.

6. The method of claim 3, wherein the estimated gyroscope bias, b*_{g}, is calculated by an equation:
$$\begin{matrix}{b}_{g}^{*} = arg {min}_{{b}_{g}} {\sum }_{( k - 1 , k ) ∈ ℰ} {‖ ( {λ}_{min} ( {M}_{k - 1 , k} ) ‖}^{2} \\ {M}_{k - 1 , k} = {\sum }_{i = 1}^{n} ( {f}_{i} \times {R}_{b}^{c} {\hat{γ}}_{{b}_{k}}^{{b}_{k - 1}} {R}_{c}^{b} {f}_{i}^{′} ) {( {f}_{i} \times {R}_{b}^{c} {\hat{γ}}_{{b}_{k}}^{{b}_{k - 1}} {R}_{c}^{b} {f}_{i}^{′} )}^{⊤} \\ {\hat{γ}}_{{b}_{k}}^{{b}_{k - 1}} = {γ}_{{b}_{k}}^{{b}_{k - 1}} Exp ( {J}_{{b}_{g}}^{γ} {b}_{g} )\end{matrix} \qquad ( 8 )$$
wherein (fᵢ, f′ᵢ) is a pair of bearing vectors in the camera; n is a number of features observed by the camera; R^{b}_{c} is a rotation matrix of the camera—IMU extrinsic calibration; M_{k-1, k} is formed by using normals from the camera; ε is a set of keyframe pairs at two consecutive times;
$${\hat{Y}}_{bk}^{bk - 1}$$
is estimated using a first-order Taylor approximation of
$${Y}_{bk}^{bk - 1}$$
and
$${J}_{bg}^{Y}$$
is how a pre-integration of rotation changes due to a difference in the gyroscope bias estimation.

7. The method of claim 1, wherein estimating the camera pose comprises estimating the camera pose using a multi-scale ICP with Compute Unified Device Architecture (CUDA) acceleration.

8. The method of claim 7, comprising performing rotation-translation-decoupled optimization to provide a starting point.

9. The method of claim 8, wherein performing the rotation-translation-decoupled optimization comprises estimating a relative rotation between a previous frame and a current frame using IMU pre-integration of rotation and a camera-IMU calibration matrix.

10. The method of claim 3, comprising updating the gyroscope bias during estimation of the camera pose.

11. The method of claim 10, wherein updating the gyroscope bias comprises differentially rendering RGB, depth, and silhouette images, and adjusting the gyroscope bias to minimize a loss between the rendered RGB, depth and silhouette images and corresponding input images while keeping Gaussian parameters fixed.

12. The method of claim 1, determine if an incoming frame is a new keyframe based on average parallax or visual similarity.

13. The method of claim 12, performing a densification procedure to determine which pixels are to be added as new Gaussians when the incoming frame is the new keyframe.

14. The method of claim 12, comprising:
hashing each incoming RGB image using perceptual hashing; and
comparing hash values of the incoming RGB image to hash values of a current keyframe to determine if the incoming RGB image is the new keyframe.

15. The method of claim 14, wherein comparing hash values of the incoming RGB image to hash values of the current keyframe comprises using Hamming distance, wherein if the Hamming distance between the incoming RGB image and all current keyframes in the buffer are greater than a predetermined threshold value, the incoming RGB image is the new keyframe.

16. The method of claim 12, comprising:
adding new Gaussians from the new keyframe to an existing Gaussians map; and
updating the Gaussians map by optimizing parameters of all 3D Gaussians.

17. A method for visual-inertial simultaneous localization and mapping (VI-SLAM), the method implemented using a control system including a processor communicatively coupled to a memory device, the method comprising: comprising:
estimating an inertial measurement unit (IMU) bias comprising an acceleration bias and a gyroscope bias, wherein the acceleration bias is estimated using Interactive Closest Point (ICP) and the gyroscope bias is estimated using epipolar constraints within a first predetermined number N frames of data, wherein a Gaussian map is initialized based on a first frame of a camera of the IMU;
estimating a camera pose of a current frame of the camera using a multi-scale ICP with Compute Unified Device Architecture (CUDA) acceleration and performing rotation-translation-decoupled optimization to provide a starting point and updating the gyroscope bias during estimation of the camera pose; and
performing dense mapping by managing the Gaussian map by optimizing 3D Gaussian parameters, expanding the Gaussian map, and compressing the Gaussian map by removing redundant Gaussians.

18. The method of claim 17, wherein the estimated gyroscope bias, b*_{g}, is calculated by an equation:
$$\begin{matrix}{b}_{g}^{*} = arg {min}_{{b}_{g}} {\sum }_{( k - 1 , k ) ∈ ℰ} {‖ ( {λ}_{min} ( {M}_{k - 1 , k} ) ‖}^{2} \\ {M}_{k - 1 , k} = {\sum }_{i = 1}^{n} ( {f}_{i} \times {R}_{b}^{c} {\hat{γ}}_{{b}_{k}}^{{b}_{k - 1}} {R}_{c}^{b} {f}_{i}^{′} ) {( {f}_{i} \times {R}_{b}^{c} {\hat{γ}}_{{b}_{k}}^{{b}_{k - 1}} {R}_{c}^{b} {f}_{i}^{′} )}^{⊤} \\ {\hat{γ}}_{{b}_{k}}^{{b}_{k - 1}} = {γ}_{{b}_{k}}^{{b}_{k - 1}} Exp ( {J}_{{b}_{g}}^{γ} {b}_{g} )\end{matrix} \qquad ( 8 )$$
wherein (fᵢ, f′ᵢ) is a pair of bearing vectors in the camera; n is a number of features observed by the camera; R^{b}_{c} is a rotation matrix of the camera—IMU extrinsic calibration; M_{k-1, k} is formed by using normals from the camera; ε is a set of keyframe pairs at two consecutive times;
$${\hat{Y}}_{bk}^{bk - 1}$$
is estimated using a first-order Taylor approximation of
$${Y}_{bk}^{bk - 1}$$
and
$${J}_{bg}^{Y}$$
is how a pre-integration of rotation changes due to a difference in the gyroscope bias estimation.

19. The method of claim 17, wherein updating the gyroscope bias comprises differentially rendering RGB, depth, and silhouette images, and adjusting the gyroscope bias to minimize a loss between the rendered RGB, depth and silhouette images and corresponding input images while keeping Gaussian parameters fixed.

20. A visual-inertial simultaneous localization and mapping (VI-SLAM) comprising:
an inertial measurement unit (IMU) unit estimating an inertial measurement unit (IMU) bias comprising an acceleration bias and a gyroscope bias, wherein the acceleration bias is estimated using Interactive Closest Point (ICP) and the gyroscope bias is estimated using epipolar constraints within a first predetermined number N frames of data, wherein a Gaussian map is initialized based on a first frame of a camera of the IMU;
an optimization unit estimating a camera pose of a current frame of the camera using a multi-scale ICP with Compute Unified Device Architecture (CUDA) acceleration and performing rotation-translation-decoupled optimization to provide a starting point and updating the gyroscope bias during estimation of the camera pose; and
a dense reconstruction unit performing dense mapping by managing the Gaussian map by optimizing 3D Gaussian parameters, expanding the Gaussian map, and compressing the Gaussian map by removing redundant Gaussians.
